(19) United States
(12) Patent Application Publication
(10) Pub. No.: US 2020/0138050 A1
(43) Pub. Date: May 7, 2020

(54) FORMULATIONS AND METHODS FOR COLOR PRESERVATION OF FRESH MEAT

(71) Applicant: WTI, Inc., Jefferson, GA (US)

(72) Inventors: Jasdeep K. SAINI, Jefferson, GA (US); Derek HULL, Jefferson, GA (US)

(21) Appl. No.: 16/625,839

(22) PCT Filed: Jun. 29, 2018
(86) PCT No.: PCT/US2018/040377

§ 371 Date: Dec. 23, 2019

Related U.S. Application Data
(60) Provisional application No. 62/526,500, filed on Jun. 29, 2017.

(51) Int. Cl. A23B 4/20; A23L 3/3472; A23L 5/41; A23L 13/60; A23L 13/40

(52) U.S. Cl. CPC A23B 4/20; A23L 3/3472; A23V 2002/00; A23L 13/60; A23L 13/428; A23L 5/41

(57) ABSTRACT

Dry mixtures are provided for color preservation of a meat product, such as a fresh ground meat product and/or a meat cut and in particular for red meat such as ground or cut beef. The mixtures can include dried vinegar and dried lemon present in a ratio (w/w) to preserve the color of the meat product while still inhibiting outgrowth of spoilage microorganisms. Methods of using the N mixtures to prepare and preserve fresh meat products, and fresh ground meat products containing the mixtures are also provided.

### CROSS-REFERENCE TO RELATED APPLICATION

This application claims priority to, and the benefit of, co-pending U.S. Provisional Application No. 62/526,500, filed Jun. 29, 2017, the contents of which are incorporated by reference in their entirety.

### TECHNICAL FIELD

The present disclosure generally relates to food additives and foods containing food additives.

### BACKGROUND

Increasing consumer demand for fresh-like foods has promoted the development of alternative methods for food preservation. Microorganisms are the main agents responsible for food spoilage and food poisoning and therefore food preservation procedures have been largely targeted towards them. Many methods have been developed for treating and preventing the growth of microorganisms in meat products. Of these, the use of vinegar (acetic acid) and salts thereof has grown in prevalence as a method to reduce the outgrowth of spoilage microorganisms in meat products.

Fresh meat products such as fresh ground beef and sausages, as well as fresh meat cuts, such as fresh cut steaks, pork chops and veal chops, are especially prone to spoilage and color deterioration. While vinegar can be used to inhibit microorganisms and delay food spoilage, the vinegar can have a detrimental impact on food color. Food color degradation is especially pronounced in ground meat products such as ground beef and other ground red meat products. Color degradation makes these meat products less palatable for most consumers although the meats may still be safe and sufficiently free of pathogenic microorganisms.

There remains a need for improved methods and compositions for preserving the color of fresh meat products, in particular fresh ground meat and red meat products, in the presence of food anti-microbial inhibitors including in particular in the presence of vinegar.

### SUMMARY

In various aspects, dry mixtures are provided for overcoming one or more of the aforementioned deficiencies. Methods of using these dry mixtures and meat products containing these dry mixtures are also provided. Applicant has discovered that, when provided in the appropriate ratio, a dried lemon composition can preserve the color of various meat products, such as those described herein, even in the presence of vinegar. Mixtures containing a dried vinegar composition and a dried lemon composition can be used to prevent the growth of microorganisms in the meat products while also preserving the color of the meat products.

In some aspects, a dry mixture is provided containing a dried lemon composition and a dried vinegar composition, wherein the ratio (w/w) of the dried lemon to the dried vinegar is about 5 to 1, about 4 to 1, about 3 to 1, about 5 to 2, about 4 to 2, about 3 to 2, or any ratio or number there between. In various aspects, the amount of dried lemon to the amount of dried vinegar can be about 60% to 80% dried lemon to about 40% to 20% dried vinegar by the combined weight of the dried lemon and dried vinegar, or any range or number there between.

The dry mixtures can be used to preserve the color of a ground meat product. For example, by applying an effective amount of the dry mixture to a ground meat product the color of the ground meat product can be preserve. The effective amount can be effective to preserve the color of the ground meat product for a period of time of at least 5 days. In some aspects, the effective amount can be effective to preserve the color of the ground meat product for a period of time from about 11 days to 17 days. In some aspects, the effective amount is effective to reduce a total color difference of the ground meat product to about 1 or less when the total color difference is measured at about 5 days after the reference time. In some aspects, the effective amount is effective to reduce a total color difference of the ground meat product to about 5 or less when the total color difference is measured at about 11 days after the reference time. The reference time can be, for example, a time that the ground meat product is prepared containing the dry mixtures described herein, time that the ground meat product is packaged, or some time thereafter.

Meat products containing the dry mixtures are also provided. The meat products can provide improved usable life for various meat products by preserving the color of the ground meat product while also reducing the outgrowth of pathogenic microorganisms. The meat products can contain an effective amount of the dry mixtures provided herein and/or can be prepared by a method described herein. The meat products can include fresh ground meat and/or fresh cut meat. The fresh ground meat can be fresh ground and/or minced beef, pork and/or poultry and can include fresh sausages containing such meat. The fresh cut meat can include, for example, steaks, pork chops and veal chops. In one or more aspects, meat products are provided containing a fresh meat, a dried vinegar composition, and an effective amount of a dried lemon composition to preserve a color of the fresh meat. In some aspects, the effective amount is effective to preserve the color of the meat product. In some aspects, the effective amount is the amount of the dry mixture, as described herein, including dried lemon, dried vinegar and optionally dried rosemary, effective to preserve the color of the meat product while also reducing the propagation of a spoilage microorganism. In some aspects, the effective amount can be effective to preserve the color of the meat for at least one, if not more than one or all of, the periods of time and/or to reduce the color difference of the meat products as described herein. The propagation of the spoilage microorganism can be compared to the propagation of the spoilage micro-organism in the otherwise same meat product except without the dry mixture when prepared and stored under the otherwise same conditions.

The meat products can include a variety of fresh ground and/or minced meat products. The dry mixtures and methods of use thereof are particularly useful for ground red meat products. Red meat products tend to brown quickly in the presence of vinegar. The dry mixtures and methods provided herein can preserve the color of red meat products. The present dry mixtures can be applied to, or mixed with, the meat to preserve the color of the meat and also provide anti-microbial properties to extend the shelf-life of the meat. In various aspects, about 0.3% to 1.3% of a dry mixture can be applied to, or mixed with, the meat by weight of the total meat formulation including the dry mixture. In some aspects, the ground meat product is a beef product, a pork product, a poultry product, or a mixture thereof. The ground meat products can be ground in some aspects, for example ground through a grinder plate. In various aspects, the meat can be ground through a grinder plate of about ¾ inch, about ½ inch, of about ¼ inch, about ⅛ inch, or less.

The dry mixtures can include a variety of dried lemon. In some aspects, the dried lemon can be prepared by buffering a lemon juice. The lemon juice can be a lemon juice concentrate. As an example, the lemon juice concentrate can be in the range of 300-500 gpl, preferably 400 gpl. The buffering of the lemon juice or lemon juice concentrate can be to adjust the pH of the lemon juice or lemon juice concentrate. The buffered lemon juice or lemon juice concentrate can have a solids content of about 35% to 70% by weight to produce the desired buffered lemon juice concentrate. In other aspects, the solids content of the desired buffered lemon juice concentrate can be in the range of about 35% to 60%, about 40% to 60%, or not more than 60%, at least 35%, or at least 35% and not more than 60%, or any range or number in between. If needed, the solids content of the lemon juice or lemon juice concentrate can be adjusted to fall within any of these ranges to produce the desired buffered lemon juice which is dried, such as by spray drying the buffered lemon juice concentrate, to produce the dried lemon. The pH of the lemon juice or lemon juice concentrate can be adjusted with a buffering or neutralizing agent. The lemon juice or lemon juice concentrate can be adjusted to a pH in the range of about 6.8 to 7.3, about 6.9 to 7.3, about 7 to 7.3, about 6.9 to 7.2, about 7 to 7.2, or not lower than 7, and up to 7.2 or up to 7.3. The buffering or neutralizing agent can be a basic composition or compound used to reduce the acidity of the lemon juice or lemon juice concentrate. The buffering or neutralizing agent can be, for example, a carbonate salt (such as sodium, potassium or calcium carbonate) a bicarbonate salt (such as sodium, potassium or calcium carbonate), or a hydroxide (such as sodium, potassium or calcium hydroxide). After drying, the dried lemon can have a pH in the range of about 6.5 to 8, about 6.8 to 8 or about 7 to 8, about 7.1 to 8, or not lower than 7 up to 8, or any range number or anywhere in between. In some aspects, the dried lemon has a moisture content of about 15%, about 10%, about 5%, or less.

The dried vinegar can prevent the outgrowth of spoilage microorganisms. In some aspects, the dried vinegar is a vinegar derived acetate composition, such as a vinegar derived acetate salt. In some aspects, the dried vinegar is derived from a vinegar such as a glacial vinegar, an apple cider vinegar, a balsamic vinegar, or a mixture thereof. In certain embodiments, the vinegar-derived acetate composition comprises a vinegar-derived sodium or potassium acetate. In an embodiment, the composition is in a powder form or in solution with vinegar. The vinegar-derived acetate composition can be an antimicrobial food additive or a buffering food additive having a pH in the range of about 4.5 to a pH of about 10.0 or any range or number anywhere in between.

In some aspects, the mixtures can further include a dried rosemary, for example a dried rosemary extract. Including the dried rosemary is optional. The dried rosemary, when present, can be included in the range of about 2%-6%, about 3% to 6% or about 3% to 5% by weight of the mixture, or any range or number there between. When present in the mixture the dried rosemary can be added in proportion to the ratio of dried lemon to dried vinegar. Thus, for example, if 5% dried rosemary is added (or included) to a mixture of 4 parts dried lemon to 1 part dried vinegar (a ratio of 4:1, or 80% dried lemon and 20% dried vinegar) by weight, the final mixture would be 76% dried lemon, 19% dried vinegar, and 5% dried rosemary. In various aspects, the dried rosemary can be prepared by drying rosemary or rosemary extract onto a carrier, such as a carried described herein.

In some aspects, mixtures are also provided including dried lemon (such as described herein), dried rosemary, and a suitable carrier. The rosemary can be a dried rosemary, such as a dried rosemary extract. The suitable carrier can be a carrier as described herein. These mixtures can be provided without, i.e. in the absence of vinegar in particular the dried vinegar described herein.

In some aspects, the mixtures and/or the rosemary include a suitable carrier. A suitable carrier can include a dextrin, a maltodextrin, a whey solid, a dextrose, a wheat flour, a starch, a gypsum, a sugar, a sugar alcohol, a magnesium oxide, a magnesium carbonate, a calcium stearate, a colloidal silicon dioxide, a microcrystalline cellulose, a powered cellulose, a dicalcium phosphate, or a combination thereof.

In an embodiment, a dry mixture for preserving color of a meat product is provided. The dry mixture can comprise a dried lemon and a dried vinegar, wherein a ratio (w/w) of the dried lemon to the dried vinegar is within the range of 5 to 1, or any range or number therebetween. The ratio of the dried lemon to the dried vinegar can be about 60% to 80% dried lemon to about 40% to 20% dried vinegar by weight based on the combination of the two. The ratio of the dried lemon to the dried vinegar can be about 80% to 90% dried lemon to 20% to 10% dried vinegar by weight based on the combination of the two. The dry mixture can optionally include rosemary. The rosemary can be a dried rosemary, for example a dried rosemary extract.

In any one or more aspects, the dried lemon can be prepared by a process comprising: adjusting a lemon juice or lemon juice concentrate to a pH of about 6.8 to 7.3 having a solids content of about 35% to 70% by weight to produce a buffered lemon juice concentrate; and drying the buffered lemon juice concentrate to produce the dried lemon. The pH of the lemon juice concentrate can be adjusted with a basic buffering or neutralizing agent. The dried lemon can have a pH of about 6.5 to 8.0. The dried lemon can have a moisture content of about 15% or less. The dried vinegar can be a vinegar derived acetate salt. The dried vinegar can be derived by treating vinegar with a basic neutralizing agent to produce a partially-neutralized vinegar with a pH of below 7.0, drying the partially neutralized vinegar, and adding vinegar back to the dried partially neutralized vinegar to produce a dried vinegar composition having a pH of about 4.5 to about 10.0. The dry mixture, or any one or more of its components, can comprise a suitable carrier. The dry suitable carrier can be selected from the group consisting of a dextrin, a maltodextrin, a whey solid, a dextrose, a wheat flour, a starch, a gypsum, a sugar, a sugar alcohol, a magnesium oxide, a magnesium carbonate, a calcium stearate, a colloidal silicon dioxide, a microcrystalline cellulose, a powered cellulose, a dicalcium phosphate, and a combination thereof.

In an embodiment, a dry mixture is provided for preserving color of a meat product, the dry mixture comprising a dried lemon, a dried rosemary, and a suitable carrier, without vinegar or dried vinegar. The dried lemon can be prepared by a process comprising: adjusting a lemon juice or lemon juice concentrate to a pH of about 6.8 to 7.3 having a solids content of about 35% to 70% by weight to produce a buffered lemon juice concentrate; and drying the buffered lemon juice concentrate to produce the dried lemon. The pH of the lemon juice concentrate can be adjusted with a basic buffering or neutralizing agent. The dried lemon can have a pH of about 6.5 to 8.0. The dried lemon can have a moisture content of about 15% or less. The dried vinegar can be derived by treating vinegar with a basic neutralizing agent to produce a partially-neutralized vinegar with a pH of below 7.0, drying the partially neutralized vinegar, and adding vinegar back to the dried partially neutralized vinegar to produce a dried vinegar composition having a pH of about 4.5 to about 10.0. The suitable carrier can be selected from the group consisting of a dextrin, a maltodextrin, a whey solid, a dextrose, a wheat flour, a starch, a gypsum, a sugar, a sugar alcohol, a magnesium oxide, a magnesium carbonate, a calcium stearate, a colloidal silicon dioxide, a microcrystalline cellulose, a powered cellulose, a dicalcium phosphate, and a combination thereof. The dried lemon and the dried rosemary can be prepared and provided as otherwise described herein.

In an embodiment, a method of preserving color of a meat product in need of color preservation is provided. The method can comprise applying an effective amount of a dry mixture in any one or more of the aspects described herein to the meat product, wherein the effective amount is effective to preserve the color of the meat product for a period of time of at least 5 days. The effective amount of the dry mixture can be in the range of about 0.3% to 1.3% of the dry mixture by weight of the total meat formulation including the dry mixture. The meat product can be a fresh red meat product. The meat product can be selected from the group consisting of a beef product, a pork product, a poultry product, and a mixture thereof. The meat product can be a ground meat product. The effective amount can be effective to preserve the color of the fresh ground meat for a period of time from about 11 days to 17 days. The effective amount of the dry mixture can be an amount effective to reduce the propagation of a spoilage micro-organism in the meat product; wherein the propagation of the spoilage micro-organism is compared to the propagation of the spoilage micro-organism in the otherwise same meat product except without the dry mixture when prepared and stored under the otherwise same conditions. The effective amount can be effective to reduce a total color difference of the meat product to about 1 or less when the total color difference is measured at about 5 days after a reference time. The effective amount can be effective to reduce a total color difference of the meat product to about 5 or less when the total color difference is measured at about 11 days after a reference time. The reference time can be a time immediately after the meat product is prepared containing the dry mixture and packaged.

In an embodiment, a meat product is provided comprising an effective amount of a dry mixture in any one or more of the aspects described herein to preserve a color of the meat product. The meat product can be prepared by any method according to any one or more of the methods described herein.

In an embodiment, a meat product is provided comprising: a ground meat, a dried vinegar, and an amount of a dried lemon effective to preserve a color of the meat product. The ratio (w/w) of the dried lemon to the dried vinegar can be within the range of about 5 to 1. The ratio of the dried lemon to the dried vinegar can be about 60% to 80% dried lemon to 40% to 20% dried vinegar by weight based on the combination of the two. The dried vinegar can be present in an effective amount to reduce the propagation of a spoilage micro-organism in the meat product; wherein the dried lemon is present in an effective amount to preserve a color of the ground meat product for a period of time of at least 5 days; and wherein the propagation of the spoilage micro-organism is compared to the propagation of the spoilage micro-organism in the otherwise same meat product except without the dry mixture when prepared and stored under the otherwise same conditions. The effective amount can be effective to preserve the color of the meat product for a period of time of at least 5 days.

In any one or more aspects of any one or more of the embodiments herein, the meat product can be a red meat product. The meat product can be selected from the group consisting of a beef product, a pork product, a poultry product, and a mixture thereof. The effective amount of the dry mixture can be an amount effective to preserve the color for a period of time from about 11 days to 17 days. The effective amount can be effective to reduce the propagation of a spoilage micro-organism in the meat product; wherein the propagation of the spoilage micro-organism is compared to the propagation of the spoilage micro-organism in the otherwise same meat product except without the dry mixture when prepared and stored under the otherwise same conditions. The effective amount can be effective to reduce a total color difference of the meat product to about 1 or less when the total color difference is measured at about 5 days after a reference time. The effective amount can be effective to reduce a total color difference of the meat product to about 5 or less when the total color difference is measured at about 11 days after a reference time. The reference time can be a time immediately after the meat product is prepared containing the dry mixture and packaged. The meat product can be a fresh ground meat product. The meat product can be a meat cut.

Other compositions, methods, features, and advantages of dry mixtures for preserving the color of meat products and uses thereof will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a photographic image showing the color difference between a control sample of ground beef without additive (left) and a test sample of ground beef containing 0.7% of an exemplary color preserving formulation of the present disclosure at 11 days of storage at 38±1° F.

FIG. 2 is a photographic image showing the color difference between a control sample of fresh ground meat (beef) without additive (upper left), a sample of the fresh ground meat containing 0.7% by weight of an exemplary color preserving formulation or composition (of the present disclosure lower left), and a sample of the fresh ground meat containing 0.5% by weight of an exemplary color preserving formulation of the present disclosure (lower right), both at 11 days of storage at 38±1° F.

FIG. 3 is a photographic image showing the color difference between a control sample of fresh pork sweet Italian sausage without additive (far left) and test samples of the sausage containing 0.75% and 1.0% of an exemplary color preserving formulation of the present disclosure and a test sample of the sausage containing for comparison 0.02% of a commercially available chemical treatment (far right) at day 0.

FIG. 4 is a photographic image showing the color difference between the samples of FIG. 3 at day 6.

FIG. 5 is a photographic image showing the color difference between the samples of FIG. 3 at day 14.

### DETAILED DESCRIPTION

In various aspects, dry mixtures are provided for preserving the color of meat products. The mixtures can include a dried vinegar composition and a dried lemon composition in an effective amount to preserve the color of the meat product. In some aspects, the color can be preserved while also reducing the outgrowth of a spoilage microorganism. For example, while vinegar can reduce the spoilage of a ground meat product, vinegar also leads to color deterioration of meat products, especially ground red meat products. Applicant has found that when dried vinegar is applied with an effective amount of dried lemon, the color of the ground meat can be preserved for an extended period of time.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of food preparation, food preservation, and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “meat product”, as used herein, includes any food product that primarily contains animal tissue, e.g. contains at least 70%, at least 80%, at least 90%, or at least 95% animal tissue including, but not limited to, beef, pork, poultry, and fish. Other animal tissues can include the tissue of many ungulates that can be used for human consumption such as deer, oxen, antelope, sheep, and goat. The term “meat product” as used herein encompasses processed meats such as sausages, hamburgers, luncheon meats and cold cuts, as well as meat cuts such as steaks, pork chops and veal chops.

The term “beef product”, as used herein, refers to any food that primarily contains cow tissue, e.g. contains at least 70%, at least 80%, at least 90%, or at least 95% cow, including calf, tissue. The term “cow” refers to any animal of the genus Bos, such as for example the Bos Taurus, which is used as a food source for human consumption. Exemplary cow breeds used as commercial livestock include the Holstein, Ayrshire, Angus, and Umousin.

The term “poultry product”, as used herein, refers to any food that primarily contains poultry tissue, e.g. contains at least 70%, at least 80%, at least 90%, or at least 95% poultry tissue. The term “poultry” refers to any edible birds such as chickens, turkeys, ducks, geese, and squab. Poultry can include animals of the genus Gallus, for example the Gallus gallus domesticus, which is used as a food source for human consumption. Poultry can include animals of the genus Meleagris, for example the Meleagris gallopavo, which is used as a food source for human consumption.

The term “pork product”, as used herein, refers to any food product that primarily contains pig tissue, e.g. contains at least 70%, at least 80%, at least 90%, or at least 95% pig tissue. The term “pig” refers to any animal of the genus Sus, such as for example Sus scrofa, which is used as a food source for human consumption. Exemplary pig breeds used as commercial livestock include Berkshire, Large White, Duroc, Hampshire, Landrace, Meishan, Pietrain, and many others.

The term “red meat,” as used herein, refers to a meat product containing about 0.05% or more of myoglobin or hemoglobin pigment. Examples of red meat include, but are not limited to, beef, pork, lamb, and dark-colored chicken.

The terms “fresh ground meat” and “fresh ground meat product,” as used herein, include any meat product, including in particular, such as beef, pork, and poultry, and mixtures thereof, that is mechanically processed into small pieces using methods such as grinding, mincing and/or chopping and that is unprocessed and meant or intended to be cooked.

As used herein, an “effective amount” is at least the minimum concentration or amount required to have a measurable decrease in one or more changes contributing to decreased shelf life of a food product including, but not limited to, water loss, oxidation, odor development, discoloration, or microbial changes such as the growth rate or concentration of one of more microorganisms that contribute to decreased shelf life of a food product.

The term “daily value”, as used herein, can be given the meaning supplied by the United States Food and Drug Administration (U.S. F.D.A.), for example as described in the “Guidance for Industry: A Food Labeling Guide” published by the Office of Nutrition, Labeling, and Dietary Supplements of the U.S. F.D.A., last revised January 2013. There are two sets of reference values for reporting nutrients in nutrition labeling: 1) Daily Reference Values (DRVs) and 2) Reference Daily Intakes (RDIs). These values assist consumers in interpreting information about the amount of a nutrient present in a food and in comparing nutritional values of food products. DRVs are provided for total fat, saturated fat, cholesterol, total carbohydrate, dietary fiber, sodium, potassium, and protein. RDIs are provided for vitamins and minerals and for protein for children less than four years of age and for pregnant and lactating women. To limit consumer confusion, the single term “daily value”, often denoted as “DV”, is used to designate both the DRVs and RDIs. For substances where no RDI or DRV has been established, the DV can be taken, for example, as the average daily intake of the substance based on food intake concentrations for persons over 2 years old on a standard 2,000-calorie diet.

The term “consumable salt”, as used herein, refers to derivatives of a compound, wherein the parent compound is modified by making acid or base salts thereof which are, within the scope of sound scientific judgment, suitable for consumption by human beings and animals without excessive toxicity, irritation, allergic response, or other problems or complications commensurate with a reasonable benefit/risk ratio. Example of consumable salts include but are not limited to mineral or organic acid salts of basic residues such as amines; and alkali or organic salts of acidic residues such as carboxylic acids. The consumable salts include the conventional non-toxic salts or the quaternary ammonium salts of the parent compound formed, for example, from non-toxic inorganic or organic acids. Such conventional non-toxic salts include those derived from inorganic acids such as hydrochloric, hydrobromic, sulfuric, sulfamic, phosphoric, and nitric acids; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, tolunesulfonic, naphthalenesulfonic, methanesulfonic, ethane disulfonic, oxalic, and isethionic salts.

The consumable salts of the compounds can be synthesized from the parent compound, which contains a basic or acidic moiety, by conventional chemical methods. Such salts can be prepared by reacting the free acid or base forms of these compounds with a stoichiometric amount of the appropriate base or acid in water or in an organic solvent, or in a mixture of the two; generally, non-aqueous media like ether, ethyl acetate, ethanol, isopropanol, or acetonitrile are preferred. Lists of suitable salts can be found in Remington's Pharmaceutical Sciences, 20th ed., Lippincott Williams & Wilkins, Baltimore, Md., 2000, p. 704; and “Handbook of Pharmaceutical Salts: Properties, Selection, and Use,” P. Heinrich Stahl and Camille G. Wermuth, Eds., Wiley-VCH, Weinheim, 2002.

The term “generally recognized as safe” or “GRAS”, as used herein, refers to substances generally recognized, among qualified experts, as having been adequately shown to be safe under the conditions of its intended use, for example by general recognition of safety through scientific procedures under 21 C.F.R § 170.30(b) or by general recognition of safety through experience based on common use in foods by a substantial history of consumption for food use under 21 C.F.R § 170.30(c). GRAS substances can include those substances listed in 21 C.F.R. § 182.

As used herein, the term “shelf life” refers to the period of time that a food product remains saleable to retail customers and remains fit and safe for use or consumption. Changes including, but not limited to, oxidation, odor development, discoloration in addition to microbial changes can alter the shelf life of the food product. Spoilage micro-organisms may also act to discolor meat, making such meat unappealing and undesirable for human consumption. Pathogenic micro-organisms may have proliferated in this time period to a level wherein they can cause disease in an animal that consumes the food product. Indicators of shelf life include total aerobic count, such as the total aerobic bacteria and/or the lactic acid bacteria, yeast and mold present.

“Food preservation”, as used herein, refers to methods which maintain or enhance food safety or palatability for example, by controlling the growth and proliferation of pathogenic and spoilage micro-organisms, thus guarding against food poisoning and delaying or preventing food spoilage, or by guarding against water loss, discoloration, or the development of unpleasant odors associated with food spoilage. Food preservation helps food remain safe and palatable for consumption for longer periods of time (i.e. improves the shelf life) and inhibits or prevents nutrient deterioration and/or organoleptic changes which cause food to become less palatable.

The term “micro-organism” as used herein, includes bacteria, fungi and parasites. Non-limiting examples of micro-organisms that can be controlled using the formulations and methods described herein include bacteria from the genus Aeromonas (e.g. A. hydrophilia), Arcobacter, Bacillus (e.g. B. cereus), Brochothrix (e.g. B. thermosphacta), Campylobacter (e.g. C. jejuni), Camobacterium (e.g. C. piscicola), Chlostridium (e.g. C. perfringens, C. botulinum), Enterobacteriacae, Escherichia (e.g. E. coli O157:H7), Listeria (e.g. L. monocytogenes), Pseudomonas (e.g. P. putida, P. fluorescens), Salmonella (e.g. S. Typhimurium), Serratia (e.g. S. liquefaciens), Shigella, Staphylococcus (e.g. S. aureus), Vibrio (e.g. V. parahaemolyticus, V. cholerae) and Yersina (e.g. Y. enterocolitica); fungi such as Aspergillus flavum and Penicillium chrysogenum; parasites such as Amoebiasis (Emoebiasis histolytica), Balantidiosis (Balantidiosis coli), Entamoeba histolytica, Cryptosporidiosis (e.g. Cryptosporidium parvum), Cyclosporidiosis (e.g. Cyclospora cayetanensis), Giardiasis (e.g. Giardia lamblia, Giardia intestinalis), Isosporiasis (Isosporiasis belli), Microsporidiosis (Enter ocytozoon bieneusi, S. intestinalis), Trichinella spiralis and Toxoplasma gondii. The term micro-organism also refers to vegetative or dormant forms of bacteria and fungi, such as spores wherein activation of the growth cycle may be controlled using the methods provided herein.

The term “spoilage micro-organism” as used herein refers to a micro-organism that acts to spoil food. Spoilage micro-organisms may grow and proliferate to such a degree that a food product is made unsuitable or undesirable for human or animal consumption. The production of undesirable by-products by the microorganism, such as carbon dioxide, methane, nitrogenous compounds, butyric acid, propionic acid, lactic acid, formic acid, sulfur compounds, and other gases and acids can cause detrimental effects on the foodstuff alteration of the color of meat surfaces to a brown, grey or green color, or creation of an undesirable odor. The color and odor alterations of food products due to the growth of spoilage micro-organisms frequently result in the product becoming unsaleable.

The term “pathogenic micro-organism” as used herein refers to a micro-organism capable of causing disease or illness in an animal or a human, for example, by the production of endotoxins, or by the presence of a threshold level of micro-organisms to cause food poisoning, or other undesirable physiological reactions in humans or animals.

The term “total color difference,” as used herein, refers to the straight-line distance based on L*, a*, b* between the color of a food product at a specified time and the color at a reference time, when the colors are measured by a Hunter Lab Colorimeter. Unless otherwise specified or clear from context herein, the reference time for total color difference or delta can be measured with respect to the day of preparation, typically referred to as “Day 0”. The delta or difference in color is a unitless number referred to as the “Delta E” value. On a typical scale, the Delta E value will range from 0 to 100.

Dry Mixtures for Color Preservation

A variety of dry mixtures are provided for the preservation of color in a meat product, especially in red meat products. In some aspects, a dry mixture is provided containing a dried lemon composition and a dried vinegar composition. The ratio (w/w) of the dried lemon to the dried vinegar can be about 5 to 1, about 4 to 1, about 3 to 1, about 5 to 2, about 4 to 2, about 3 to 2, or any ratio or number there between, for example about 2.75-2.25 to 1. In various aspects, the amount of dried lemon to the amount of dried vinegar can be about 60% to 80% dried lemon to about 40% to 20% dried vinegar by the combined weight of the dried lemon and dried vinegar, or any range or number there between.

The dry mixtures can be used to preserve the color of a meat product. For example, by applying an effective amount of the dry mixture to a meat product the color of the meat product can be preserved. The effective amount can be effective to preserve the color of the meat product for a period of time of at least 5 days, at least 8 days, at least 11 days, or at least 14 days. In some aspects, the effective amount can be effective to preserve the color of the meat product for a period of time from about 8 to 14 days, about 11 to 14 days, about 11 days to 17 days, or about 14 to 17 days.

In some aspects, the effective amount is effective to reduce a total color difference of the meat product to about 6, 5, 4, 3, 2, 1, or less when the total color difference is measured at about 5 days. In some aspects, the effective amount is effective to reduce a total color difference of the meat product to about 11, 10, 8, 5, 3, or less when the total color difference is measured at about 8 days. In some aspects, the effective amount is effective to reduce a total color difference of the meat product to about 12, 10, 8, 6, 5, or less when the total color difference is measured at about 11 or at about 14 days.

The dry mixtures can include a variety of dried lemon. In some aspects, the dried lemon is prepared by adjusting (or buffering) a lemon juice or lemon juice concentrate. The pH of the lemon juice or lemon juice concentrate can be adjusted by adding a basic compound or composition to the lemon juice or lemon juice concentrate, such as described elsewhere herein. The pH of the lemon juice or lemon juice concentrate can be adjusted to a pH in the range of about 6.7 to 7.3, about 6.8 to 7.3, about 6.8 to 7.2, about 6.9 to 7.2, about 6.9 to 7.1, about 7 to 7.3, about 7 to 7.2, or not lower than 7 and up to 7.2 or up to 7.3, and having a solids content of about 35% to 70%, about 35% to 60%, about 40% to 65%, about 40% to 60%, about 45% to 60%, or not more than 60% and at least 35%, or any range or number in between, by weight to produce a buffered lemon juice concentrate; and drying (for example by spray drying) the buffered lemon juice concentrate to produce the dried lemon. After drying, the dried lemon can have a pH, in some aspects, of about 6.5 to 8.0, about 6.8 to 8, about 6.5 to 7.5, about 7.0 to 7.5, about 7 to 8, about 7.1 to 8, or not lower than 7 and up to 8, or any range number or anywhere in between. In some aspects, the dried lemon has a moisture content of about 20%, about 15%, about 10%, about 5%, or less.

The dried vinegar can prevent the outgrowth of spoilage microorganisms. In some aspects, the dried vinegar is a vinegar derived acetate composition, such as a vinegar derived acetate salt. In some aspects, the dried vinegar is derived from a vinegar such as a glacial vinegar, an apple cider vinegar, a balsamic vinegar, or a mixture thereof. In certain embodiments, the vinegar-derived acetate composition comprises a vinegar-derived sodium or potassium acetate. In an embodiment, the composition is in a powder form or in solution with vinegar. The vinegar-derived acetate composition can be an antimicrobial food additive or buffering food additive having a pH of about 4.5 to a pH of about 10.0, or any range or number there between. In any one or more aspects, the vinegar-derived acetate composition comprises a vinegar-derived acetate such as sodium acetate or potassium acetate, and vinegar and has a pH of about 4.5 to 7.0, or any range or number there between. The composition can be produced by treating vinegar with a basic neutralizing agent, such as a carbonate salt, a bicarbonate salt or a hydroxide, as described herein, to produce a partially-neutralized vinegar with a pH of below 7.0. The partially neutralized vinegar is dried, such as by evaporation and heat, to produce a dried vinegar, such as dried sodium acetate or potassium acetate. In an embodiment, vinegar can be added back to the acetate to produce a dried vinegar composition having a pH of about 4.5 to about 7.0, or any range or number there between. By “dried” vinegar, we mean a composition having a moisture content of about 15%, about 10%, about 5%, or less.

In any one or more aspects, the present disclosure provides a vinegar-derived acetate composition that can be a buffering composition comprising vinegar-derived acetate, such as sodium acetate or potassium acetate, and vinegar and having a pH of about 7.0 to about 10.0, or any range or number there between. The buffering composition can be produced by treating vinegar with a basic neutralizing agent, such as a carbonate salt, a bicarbonate salt, or a hydroxide, as described herein, to produce a partially-neutralized vinegar with a pH of below 7.0. The partially neutralized vinegar can be dried, such as by evaporation and heat, to produce the dried vinegar buffering composition, such as sodium acetate or potassium acetate. Vinegar is added back to the acetate to produce a buffering dried vinegar composition having a pH of about 7.0 to about 10.0, or any range or number there between.

In various aspects, the amount of basic neutralizing agent necessary to partially neutralize the vinegar can be in the range of about 3.5 pounds to about 5 pounds per about 10 pounds of vinegar.

In some aspects, the mixtures can further include a dried rosemary, for example a dried rosemary extract. Including the dried rosemary is optional. The dried rosemary, when present, can be included in the range of about 2%-6%, about 3% to 6% or about 3% to 5% by weight of the mixture, or any range or number there between. When present in the mixture the dried rosemary can be added in proportion to the ratio of dried lemon to dried vinegar. Thus, for example, if 5% dried rosemary is added (or included) to a mixture of 4 parts dried lemon to 1 part dried vinegar (a ratio of 4:1, or 80% dried lemon and 20% dried vinegar) by weight, the final mixture would be 76% dried lemon, 19% dried vinegar, and 5% dried rosemary. In various aspects, the dried rosemary can be prepared by drying rosemary or rosemary extract onto a carrier, such as a carried described herein.

In some aspects, the mixtures include a suitable carrier. A suitable carrier can include a dextrin, a maltodextrin, a whey solid, a dextrose, a wheat flour, a starch, a gypsum, a sugar, a sugar alcohol, a magnesium oxide, a magnesium carbonate, a calcium stearate, a colloidal silicon dioxide, a microcrystalline cellulose, a powered cellulose, a dicalcium phosphate, or a combination thereof.

Meat Products

Meat products containing the dry mixtures are also provided. The meat products can provide improved usable life for meat products, especially fresh ground meat products and fresh meat cuts, by preserving the color of the meat product while also reducing the outgrowth of pathogenic microorganisms. The meat products can contain an effective amount of the dry mixtures provided herein and/or can be prepared by a method described herein. In some aspects, the effective amount is effective to preserve the color of the meat product. In some aspects, the effective amount is effective to preserve the color of the meat product while also reducing the propagation of a spoilage microorganism. In some aspects, the effective amount can be effective to preserve the color of the meat for the periods of time and/or to reduce the color difference of the meat products as described herein. The propagation of the spoilage microorganism can be compared to the propagation of the spoilage micro-organism in the otherwise same ground meat product except without the dry mixture when prepared and stored under the otherwise same conditions.

In some aspects, meat products are provided containing a meat product, for example a fresh ground meat or a fresh meat cut, a dried vinegar, and an effective amount of a dried lemon to preserve a color of the ground meat. In some aspects, the ratio (w/w) of the dried lemon to the dried vinegar can be any one or more of the aspects described elsewhere herein. In various aspects, a dried mixture of the dried lemon, dried vinegar, and optionally dried rosemary (in the ratios or proportions described herein) can be applied to the meat product. The amount of the dried mixture applied to the meat product can be in the range of about 0.3% to 1.3%, about 0.4% to 1.2%, about 0.5% to 1.1%, about 0.5% to 1%, or at least 3% to not more than 1.3%, or preferably not more than 1%, by weight of the total meat formulation, including the mixture. In some aspects, the dried lemon is present in an amount of about 1%, about 0.8%, about 0.7%, about 0.6%, about 0.5%, or less by weight based upon a total weight of the meat product. It has been found that such small levels of dried lemon can be effective to preserve the color of a meat product. In some aspects, the dried vinegar is present in an amount of about 0.5%, 0.4%, 0.3%, 0.2%, or less by weight based upon a total weight of the meat product.

The meat products can include a variety of fresh ground meat and cut meat products. The dry mixtures and methods of use thereof are particularly useful for red meat products. Red meat products tend to brown quickly in the presence of vinegar. The dry mixtures and methods provided herein can preserve the color of red meat products. In some aspects, the meat product is a beef product, a pork product, a poultry product, or a mixture thereof. The fresh ground meat products can be finely ground in some aspects, for example ground through a grinder plate of about ½ inch, about ¼ inch, about ⅛ inch, or less.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

Test fresh ground meat samples or products were produced by trimming USDA Choice Boneless Beef Eye of Round to P, 90/10 Lean/Fat target. The beef was ground through a ⅛″ (3.175 mm) grinder plate. The ground beef was either untreated (control) or mixed with the designated treatments. The beef (control or treated) was portioned and packaged into 3 mil PE barrier pouches. Packages were vacuumed and then gas flushed with 80% O₂, 20% CO₂ food grade gas mixture and sealed. All samples were stored at 38±1° F. under ambient light display setting for shelf-life and color analysis.

Enumeration of Bacterial Populations

Samples were analyzed for shelf-life testing at day 0, 5, 8, 11, and 14 using Aerobic Plate Count (AOAC 990.12). Samples were also analyzed at day 0, 6, 9, 13, and 14 using the following tests:

(1) Aerobic Plate Count (AOAC 990.12), (2)

(2) Lactic Acid Bacteria (Compendium Ch 19)

(3) Yeast and Mold Count (AOAC 997.02)

Duplicate samples were plated on appropriate media, Aerobic Plate Count Plate (APC) Petrifilm and Yeast and Mold Petrifilm for enumeration of total aerobic bacteria, yeast and mold, respectively. Lactic acid bacteria were enumerated using deMan Rogosa Sharpe (MRS) agar. Plates were incubated at 35° C. for 24-48 h for total aerobic count and at room temperature for up to 72 h for yeast and mold and lactic acid bacteria.

Prototype 1 includes 0.5% dried lemon (w/w) and 0.2% dried vinegar (w/w) based upon a total weight of the fresh ground beef product. Color Testing:

Color analysis was performed using Hunter Lab Colorimeter. At each sampling point, I, a, and b values were recorded.

Results

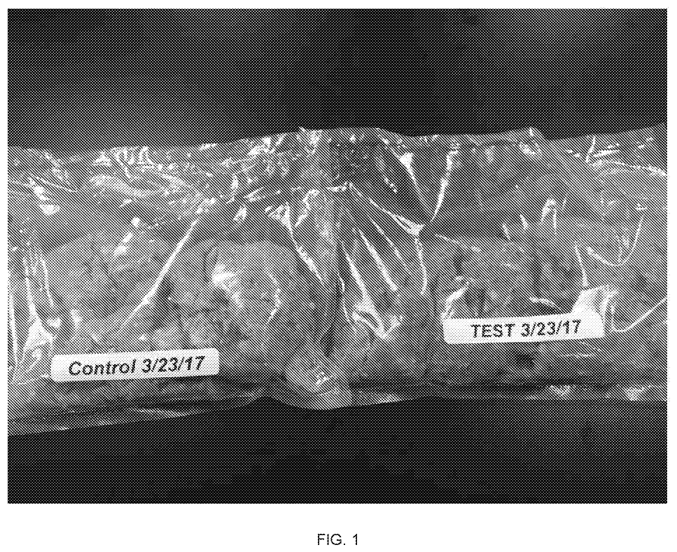

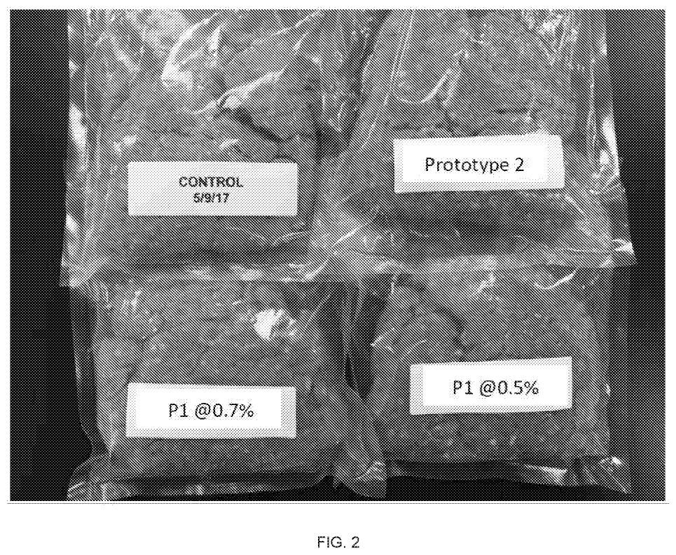

Table 1 shows total aerobic count as a shelf-life indicator in ground beef held at 38±1° F. for 14 days. End of shelf life is typically considered to be 100,000-1,000,000 colony forming units (cfu) per g total plate count. The prototype 1 @ 0.7% was effective in extending shelf-life of ground beef to 14 days while maintaining color. The differences in the color observed have been presented as L*, a*, b*, and Delta E (ΔE) values in Tables 2-6. FIGS. 1-2 show the visual color difference between control and test samples on day 11.

Delta E* (Total Color Difference) is calculated based on delta L*, a*, b* color differences and represents the distance of a line between the sample and standard. In addition to quantifying the overall color difference between a sample and standard color, Delta E* was intended to be a single number metric for Pass/Fail tolerance decisions. Effectively a Delta E* tolerance value defines an acceptance sphere around the standard or target color. The lower the Delta E* value is, the closer the sample is to the standard. A Delta E* value of 0.00 means the color of the sample is identical to the color of the standard. In Table 5 ΔE values have generated in comparison to control indicating change in color from day 0. Higher values of Delta E in control indicates greater change in color from day 0.

TABLE 1
Average Total aerobic count (log cfu/g, n = 2) in fresh ground beef held
at 38 ±1° F. for 14 days

| | Total Aerobic Count Log CFU/g | | | | |
|---|---|---|---|---|---|
| | Day 0 | Day 5 | Day 8 | Day 11 | Day 14 |
| Ground Beef | 4.22 | 4.08 | 4.87 | 5.97 | 6.68 |
| Control | | | | | |
| Ground Beef | 4.02 | 4.10 | 3.98 | 4.67 | 5.81 |
| with Prototype 1 | | | | | |
| @0.7% | | | | | |

TABLE 2
Average L* values (n = 2) as measured by Hunter Lab Colorimeter in
ground beef held at 38 ±1° F. for 14 days

| | Day 0 | Day 5 | Day 8 | Day 11 | Day 14 |
|---|---|---|---|---|---|
| Control | 40.895 | 39.655 | 41.18 | 42.345 | 41.61 |
| Prototype 1 | 38.265 | 37.775 | 38.87 | 38.53 | 37.105 |
| @0.7% | | | | | |

TABLE 3
Average a* values (n = 2) as measured by Hunter Lab Colorimeter in
ground beef held at 38 ±1° F. for 14 days

| | Day 0 | Day 5 | Day 8 | Day 11 | Day 14 |
|---|---|---|---|---|---|
| Control | 19.38 | 12.27 | 8.08 | 7.83 | 7.545 |
| Prototype 1 | 17.205 | 17.2 | 14.78 | 13.1 | 12.165 |
| @0.7% | | | | | |

TABLE 4
Average b* values (n = 2) as measured by Hunter Lab Colorimeter in
ground beef held at 38 ±1° F. for 14 days

| | Day 0 | Day 5 | Day 8 | Day 11 | Day 14 |
|---|---|---|---|---|---|
| Control | 13.995 | 11.765 | 10.84 | 10.855 | 11.29 |
| Prototype 1 | 12.415 | 12.525 | 11.945 | 10.88 | 11.54 |
| @0.7% | | | | | |

TABLE 5
ΔE values on ground beef held at 38 ±1° F. for 14 days

| | Day 0-5 | Day 0-8 | Day 0-11 | Day 0-14 |
|---|---|---|---|---|
| Control | 7.55 | 11.74 | 12.06 | 12.16 |
| Prototype 1 | 0.50 | 2.54 | 4.39 | 5.25 |
| @0.7% | | | | |

TABLE 6
Average Total aerobic count (log cfu/g, n = 2) in ground beef held
at 38 ±1° F. for 14 days

| | Total Aerobic Count (log cfu/g) | | | |
|---|---|---|---|---|
| | Day 0 | Day 6 | Day 9 | Day 13 |
| Control | 3.87 | 4.42 | 4.51 | 5.02 |
| Prototype 1 @ 0.7% | 3.95 | 3.93 | 4.16 | 3.90 |
| Prototype 1 @ 0.5% | 3.97 | 3.96 | 4.06 | 3.78 |

Tables 7 and 8 present total aerobic bacteria counts and color difference, Delta E, values for treatment of samples of fresh ground meat prepared as described above using various of the present compositions in varying amounts. For example composition “T1 @ 1%” represents a first treatment of a sample of the fresh ground meat using 1% by weight of the sample of a composition of the present disclosure wherein the composition can include 80% to 90% dried lemon, 20% to 10% dried vinegar and 2% to 6% rosemary (either in dry form as described above, or in liquid form as in the Example). The data demonstrates the efficacy of the present compositions for color retention.

TABLE 7
Shelf-Life data

| | Total Aerobic Count Log CFU/g | | | | |
|---|---|---|---|---|---|
| Treatments | Day 0 | Day 7 | Day 9 | Day 13 | Day 15 |
| Control | 3.79 | 3.85 | 4.23 | 4.82 | 5.33 |
| T1 @ 1% (T6 + 0.04% | 3.76 | 3.69 | 3.83 | 5.29 | 5.74 |
| Rosemary Liquid) | | | | | |
| T2 @ 1% (T7 + 0.04% | 3.00 | 3.00 | 2.91 | 4.94 | 5.24 |
| Rosemary Liquid) | | | | | |
| T3 @ 0.04% Rosemary | 3.59 | 3.47 | 4.42 | 5.14 | 5.83 |
| Liquid) | | | | | |
| T4 @ 0.5% color blend (dry) | 2.85 | 3.14 | 3.07 | 4.71 | 4.97 |
| T5 @ 0.7% color bend (dry) | 3.28 | 3.68 | 3.74 | 4.65 | 5.63 |
| T6 @ 1% (83% Lemon + | 3.57 | 3.14 | 3.36 | 5.02 | 5.86 |
| 16.67% Vinegar) | | | | | |
| T7 @ 1% (Lemon: | 2.89 | 3.08 | 2.86 | 4.58 | 5.01 |
| Vinegar 3:1) | | | | | |

“Color blend” refers to the composition of the previous data comprising 0.5% dried lemon and 0.2% dried vinegar tested at both 0.5% and 0.7% by weight of the fresh ground meat sample. “Rosemary (liquid)” refers to a composition of rosemary alone in liquid form not having either the dried lemon or the dried vinegar. Treatments T1-T3, T6 and T7 involved use of various of the present compositions in liquid form.

TABLE 8
color data (Delta E value)

| Delta E | Day 0-7 | Day 0-9 | Day 0-13 | Day 0-15 |
|---|---|---|---|---|
| Control | 10.53886 | 11.43725 | 14.91899 | 15.94678 |
| T1 @ 1% (T6 + | 4.339093 | 5.92332 | 11.79651 | 13.64068 |
| 0.04% Rosemary | | | | |
| Liquid) | | | | |
| T2 @ 1% (T7 + | 4.576541 | 6.269121 | 8.229886 | 8.257241 |
| 0.04% Rosemary | | | | |
| Liquid) | | | | |
| T3 @ 0.04% | 6.431971 | 8.035291 | 14.79869 | 11.34081 |
| Rosemary | | | | |
| Liquid) | | | | |
| T4 @ 0.5% color | 4.843834 | 9.323708 | 11.1988 | 11.85041 |
| blend (dry) | | | | |
| T5 @ 0.7% color | 4.500344 | 9.698481 | 9.407775 | 10.10494 |
| blend (dry) | | | | |
| T6 @ 1% (83% | 5.556519 | 5.897599 | 10.13678 | 10.79597 |
| Lemon + 16.67% | | | | |
| Vinegar) | | | | |
| T7 @ 1% | 4.975696 | 7.001396 | 9.744779 | 10.31734 |
| (Lemon: | | | | |
| Vinegar 3:1) | | | | |

Delta E* (Total Color Difference) is calculated based on delta L*, a*, b* color differences and represents the distance of a line between the sample and standard.
In addition to quantifying the overall color difference between a sample and standard color, Delta*was intended to be a single number metric for Pass/Fail tolerance decisions. Effectively a delta E* tolerance value defines an acceptance sphere around the standard or target color.
The lower the delta E* value is, the closer the sample is to the standard. A delta E* value of 0.00 means the color of the sample is identical to the color of the standard.

### Example 2

Fresh pork shoulder was ground through a ½″ grinder plate. The ground material was mixed with a flavor seasoning, such as salt and spices, ice/water, and designated treatment as listed below in which the treatment was in the form of a dried mixture as described above. Then CO₂ snow was added until mixture reached 30° F. at which time the mixture was ground again through a 3/16″ plate.

The Base Formula is Listed Below.

| | |
|---|---|
| Fresh Boneless Pork Shoulder Picnic 3/16″ Ground | 95.24 |
| RO Ice/Water | 2.86 |
| Sweet Italian Sausage Seasoning | 1.90 |
| | 100.00 |

Treatment:

| Treatment # | Treatment | Usage Level |
|---|---|---|
| Control | None | NA |
| Treatment 1 | T8 (71.43% lemon, 28.59% vinegar, | 0.75% |
| | 4% rosemary) | |
| Treatment 2 | T8 (71.43% lemon, 28.59% vinegar, | 1.00% |
| | 4% rosemary) | |
| Treatment 3 | BHA Propyl Gallate | 0.02% |

The finished mixture was stuffed into 32-35 mm natural hog casings and linked. The links were placed into foam trays and over-wrapped with standard film. The product was made in the R&D meat facility and transported to the Food Safety Lab and stored at 38° F. for the duration of shelf life testing for enumeration of total plate count.
Duplicate samples were plated and averaged for each sample day (Day 0, 6, 9, 12, 14). Each day a microbial analysis was performed, pictures of the sausage links were take prior to being analyzed by a colortmeter to obtain L, A & B values which were used to determine the E value. L* indicates lightness, a* is the red/green coordinate, and b* is the yellow/blue coordinate. To determine the total color difference between all three coordinates the following formula was used:

ΔE*=[ΔL*2+Δa*2+Δb*2]½

In addition, samples were also shipped to a 3^{rd} party lab for TBAR oxidative rancidity testing which measures aldehydes (primarily malonaldehyde) created during the oxidation of lipids. These dates are slightly different due to the shipping schedule to the 3^{rd} party lab.

The following Tables 9-12 summarize the data for this study.

TABLE 9
Average total plate count populations (log₁₀ CFU/g) on fresh sweet
Italian sausage samples for up to 14-days of storage at 38° F.

| Treatment | Day 0 | Day 6 | Day 9 | Day 12 | Day 14 |
|---|---|---|---|---|---|
| Control-No treatment | 3.09 | 4.75 | 6.45 | 7.46 | 6.86 |
| T8 (71.43% lemon, 28.59% | 3.61 | 3.98 | 4.92 | 6.43 | 5.64 |
| vinegar, 4% rosemary | | | | | |
| (0.75%) | | | | | |
| T8 (71.43% lemon, 28.59% | 3.39 | 3.56 | 4.58 | 6.33 | 4.99 |
| vinegar, 4% rosemary | | | | | |
| (1.00%) | | | | | |
| BHA Propyl Gallate (0.02%) | 3.36 | 4.30 | 5.92 | 7.57 | 7.20 |

TABLE 10
Average L, a, and b values on fresh sweet Italian sausage
using a Hunterlab Model: Color Flex EZ 45/0 colorimeter.

| | Day 0 | | | Day 9 | | | Day 12 | | | Day 14 | | |
|---|---|---|---|---|---|---|---|---|---|---|---|---|
| Treatment | L | a | b | L | a | b | L | a | b | L | a | b |
| Control-No | 38.53 | 14.45 | 13.11 | 42.62 | 12.64 | 13.66 | 42.85 | 10.36 | 12.74 | 43.45 | 9.13 | 11.68 |
| treatment | | | | | | | | | | | | |
| T8 (71.43% | 43.53 | 14.04 | 11.45 | 41.47 | 13.07 | 14.00 | 43.91 | 8.65 | 11.24 | 43.92 | 10.83 | 11.62 |
| lemon, | | | | | | | | | | | | |
| 28.59% | | | | | | | | | | | | |
| vinegar, 4% | | | | | | | | | | | | |
| rosemary | | | | | | | | | | | | |
| (0.75%) | | | | | | | | | | | | |
| T8 (71.43% | 42.69 | 14.19 | 13.26 | 42.11 | 11.49 | 11.10 | 41.50 | 10.23 | 10.43 | 41.78 | 11.15 | 13.39 |
| lemon, | | | | | | | | | | | | |
| 28.59% | | | | | | | | | | | | |
| vinegar, 4% | | | | | | | | | | | | |
| rosemary | | | | | | | | | | | | |
| (1.00%) | | | | | | | | | | | | |
| BHA Propyl | 45.13 | 13.71 | 11.71 | 40.56 | 10.84 | 10.62 | 43.20 | 9.37 | 10.76 | 42.13 | 9.11 | 11.09 |
| Gallate | | | | | | | | | | | | |
| (0.02%) | | | | | | | | | | | | |

TABLE 11
Delta E values for samples during the 14-day study

| DELTA E | Day 0-9 | Day 0-12 | Day 0-14 |
|---|---|---|---|
| Control-No treatment | 4.51 | 5.96 | 7.39 |
| T8 (71.43% lemon, 28.59% vinegar, | 3.42 | 5.41 | 3.24 |
| 4% rosemary (0.75%) | | | |
| T8 (71.43% lemon, 28.59% vinegar, | 3.51 | 5.01 | 3.18 |
| 4% rosemary (1.00%) | | | |
| BHA Propyl Gallate (0.02%) | 5.51 | 4.84 | 5.53 |

TABLE 12
Results for TBA Rancidity (malonaldehyde concentration (mg/kg) in
the 4 treatments during the 16 days of storage.

| Treatment | Day 3 | Day 8 | Day 11 | Day 14 | Day 16 |
|---|---|---|---|---|---|
| Control-No treatment | 0.540 | 0.300 | 0.440 | 0.310 | 0.360 |
| T8 (71.43% lemon, | 0.420 | 0.300 | 0.310 | 0.280 | 0.420 |
| 28.59% vinegar, | | | | | |
| 4% rosemary (0.75%) | | | | | |
| T8 (71.43% lemon, | 0.510 | 0.170 | 0.390 | 0.160 | 0.400 |
| 28.59% vinegar, | | | | | |
| 4% rosemary (1.00%) | | | | | |
| BHA Propyl Gallate | 0.600 | 0.290 | 0.300 | 0.450 | 0.390 |
| (0.02%) | | | | | |

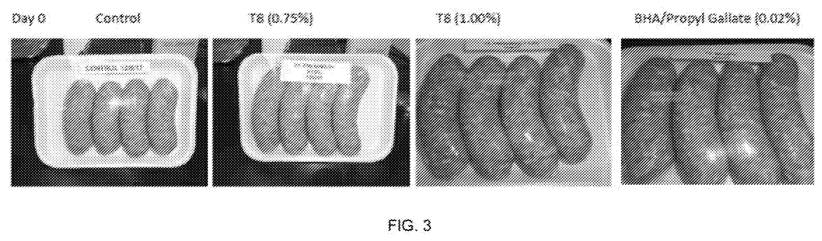

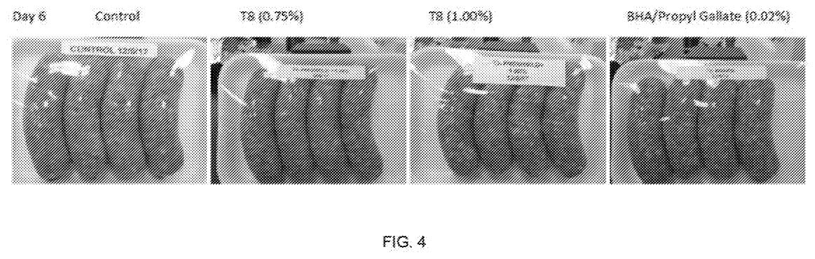

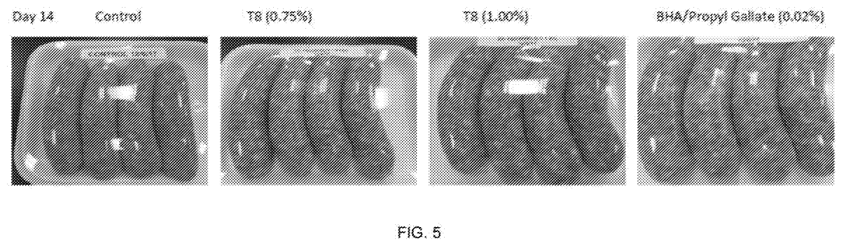

FIGS. 3-5 are photographic images showing the color differences between the samples at day 0, day 6 and day 14. The results show, for example, that treatment of the sausage with a dried mixture of the present disclosure extended color retention for at least 3 to 4 days longer than the commercially available treatment and the control sample without treatment.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A dry mixture for preserving color of a meat product, the dry mixture comprising a dried lemon, and a dried vinegar or a dried rosemary,
wherein a ratio (w/w) of the dried lemon to the dried vinegar is within the range of 5 to 1.

2. The dry mixture according to claim 1, wherein the ratio of the dried lemon to the dried vinegar is about 60% to 80% dried lemon to about 40% to 20% dried vinegar by weight based on the combination of the two.

3. The dry mixture according to claim 1, wherein the dried lemon is prepared by a process comprising:
adjusting a lemon juice or lemon juice concentrate to a pH of about 6.8 to 7.3 having a solids content of about 35% to 70% by weight to produce a buffered lemon juice concentrate; and
drying the buffered lemon juice concentrate to produce the dried lemon.

4. The dry mixture according to claim 3, wherein the pH of the lemon juice concentrate is adjusted with a basic buffering or neutralizing agent, and wherein the dried lemon has a pH of about 6.5 to 8.0.

5. (canceled)

6. The dry mixture according to claim 1, wherein the dried lemon has a moisture content of about 15% or less.

7. The dry mixture according to claim 1, wherein the dried vinegar is a vinegar derived acetate salt.

8. The dry mixture according to claim 1, wherein the dry mixture comprises a dried vinegar and the dried vinegar is derived by treating vinegar with a basic neutralizing agent to produce a partially-neutralized vinegar with a pH of below 7.0, drying the partially neutralized vinegar, and adding vinegar back to the dried partially neutralized vinegar to produce a dried vinegar composition having a pH of about 4.5 to about 10.0.

9. The dry mixture according to claim 1, further comprising both a dried vinegar and a dried rosemary.

10. The dry mixture according to claim 1, further comprising a suitable carrier.

11. The dry mixture according to claim 10, wherein the suitable carrier is selected from the group consisting of a dextrin, a maltodextrin, a whey solid, a dextrose, a wheat flour, a starch, a gypsum, a sugar, a sugar alcohol, a magnesium oxide, a magnesium carbonate, a calcium stearate, a colloidal silicon dioxide, a microcrystalline cellulose, a powered cellulose, a dicalcium phosphate, and a combination thereof.

12-18. (canceled)

19. A method of preserving color of a meat product in need of color preservation, the method comprising applying an effective amount of a dry mixture according to claim 1 to the meat product,
wherein the effective amount is effective to preserve the color of the meat product for a period of time of at least 5 days.

20. The method according to claim 19, wherein the effective amount of the dry mixture is in the range of about 0.3% to 1.3% of the dry mixture by weight of the total meat formulation including the dry mixture.

21. (canceled)

22. The method according to claim 19, wherein the meat product is selected from the group consisting of a beef product, a pork product, a poultry product, and a mixture thereof.

23-24. (canceled)

25. The method according to claim 19, wherein the effective amount is effective to reduce the propagation of a spoilage micro-organism in the meat product;
wherein the propagation of the spoilage micro-organism is compared to the propagation of the spoilage micro-organism in the otherwise same meat product except without the dry mixture when prepared and stored under the otherwise same conditions.

26. The method according to claim 19, wherein the effective amount is effective to reduce a total color difference of the meat product to about 1 or less when the total color difference is measured at about 5 days after a reference time.

27-28. (canceled)

29. A meat product comprising an effective amount of a dry mixture according to claim 1 to preserve a color of the meat product.

30. A meat product prepared by a method according to claim 19.

31. A meat product comprising:
a cut or a ground meat,
and
an effective amount of the dry mixture of claim 1 sufficient to preserve a color of the meat product.

32-33. (canceled)

34. The meat product according to claim 31, wherein the meat product is a red meat product, wherein the dried vinegar is present in an effective amount to reduce the propagation of a spoilage micro-organism in the meat product;
wherein the dried lemon is present in an effective amount to preserve a color of the ground meat product for a period of time of at least 5 days; and
wherein the propagation of the spoilage micro-organism is compared to the propagation of the spoilage micro-organism in the otherwise same meat product except without the dry mixture when prepared and stored under the otherwise same conditions.

35-39. (canceled)

40. The meat product according to claim 31, wherein the effective amount is effective to reduce a total color difference of the meat product to about 1 or less when the total color difference is measured at about 5 days after a reference time.

41-44. (canceled)
